(19) United States
(12) Patent Application Publication
(10) Pub. No.: US 2014/0362687 A1
(43) Pub. Date: Dec. 11, 2014

(54) Method And Apparatus For Improved Multicast Rate Control Using Feedback Mobiles

(71) Applicant: Alcatel-Lucent USA Inc., Murray Hill, NJ (US)

(72) Inventors: Yigal Bejerano, Springfield, NJ (US); Katherine H. Guo, Scotch Plains, NJ (US)

(73) Assignee: Alcatel-Lucent USA Inc., Murray Hill, NJ (US)

(21) Appl. No.: 13/911,816

(22) Filed: Jun. 6, 2013

(51) Int. Cl. H04L 12/825; H04L 12/18

(52) U.S. Cl. CPC H04L 47/25; H04L 12/18
USPC 370/230

(57) ABSTRACT

Various methods and devices are provided to address the need for improved multicast operation. A sender transmits (701) multicast transmissions at a first transmission rate to a multicast group of mobile devices that includes a group of feedback mobile devices. The sender receives (702) from each feedback mobile device multicast receive quality feedback corresponding to the multicast transmissions. It is then determined (703) which of the feedback mobile devices are abnormal based on the multicast receive quality feedback received. A new transmission rate for subsequent multicast transmissions to the multicast group is then determined (704) using the multicast receive quality feedback received from each feedback mobile device and the determination of which feedback mobile devices are abnormal.

### REFERENCE(S) TO RELATED APPLICATION(S)

This application is related to a co-pending application Ser. No. 12/962,362, entitled “METHOD AND APPARATUS FOR IMPROVED MULTICAST SERVICE,” filed Dec. 7, 2010, which is commonly owned and incorporated herein by reference in its entirety.

This application is related to a co-pending application Ser. No. 13/031,395, entitled “METHOD AND APPARATUS FOR IMPROVED MULTICAST SERVICE USING FEEDBACK MOBILES,” filed Feb. 21, 2011, which is commonly owned and incorporated herein by reference in its entirety.

### FIELD OF THE INVENTION

The present invention relates generally to communications and, in particular, to multicast service in wireless communication systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

Recent years have witnessed a rapid growth of mobile devices such as smart-phones and tablets equipped with wireless local area network (WLAN) interfaces that comply with the WiFi standards. While these devices allow users to access the Internet anywhere anytime, it is not straightforward to serve rich multimedia content, such as video streams, when users are clustered in crowded areas, due to a combination of high bandwidth requirements and a shortage of wireless spectrum. The inability to serve this growing demand for multimedia content using limited resources in crowded areas has prompted several solutions by both industry and academia.

Many of these solutions are typically based on dense deployment of access points (APs) for providing dedicated content delivery to each user. Such solutions, besides requiring considerable capital and operational expenditure, may not meet user expectations, due to extensive interference between adjacent cells.

Current state of the art solutions use IEEE 802.11, leveraging either unicast or multicast data delivery. Commercial solutions rely on streaming content to individual users. With standards such as 802.11ac promising speeds up to 800 Mbps per user using multi-user MIMO, it is theoretically possible to serve video streams to hundreds of users. However, large numbers of neighboring APs lead to hidden terminal problems and this, coupled with increased interference sensitivity stemming from channel bonding, makes the entire solution interference limited.

Another approach for providing multimedia content to a very large group of users leverages multicast services. While, multicast services are supported in most wireless technologies, e.g., LTE and 802.11-based networks (also termed WiFi networks), they are rarely used due to the following limitations. (a) There is no feedback mechanism from the receivers about the quality of the provided service. (b) To lessen the first problem, data transmission is typically done at lowest permitted bit-rate that, which results in very low resource utilization. To address these shortcomings of wireless multicast services, several FEC (forward-error-correction)-based and feedback-based mechanisms have been proposed. However, these mechanisms do not scale well to very large groups.

Thus, new solutions and techniques that are able to address these issues and support rich multimedia content delivery in crowded areas would meet a need and advance wireless communications generally.

### BRIEF DESCRIPTION OF THE DRAWINGS

FIG. 1 is a graph depicting simulation results, signal-to-noise ratio (SNR) verses Packet Delivery Ratio (PDR), for when the data transmission bit-rate is 9 Mpbs.

FIG. 2 is a graph depicting simulation results, SNR vs. PDR, for when the data transmission bit-rate is 12 Mpbs.

FIG. 3 is a graph depicting simulation results, SNR vs. PDR, for when the data transmission bit-rate is 18 Mpbs.

FIG. 4 is a graph depicting simulation results, SNR vs. PDR, for when the data transmission bit-rate is 24 Mpbs.

FIG. 5 is a graph depicting simulation results, SNR vs. PDR, for when the data transmission bit-rate is 36 Mpbs.

FIG. 6 is a graph depicting simulation results, SNR vs. PDR, for when the data transmission bit-rate is 48 Mpbs.

FIG. 7 is a logic flow diagram of functionality performed by a multicast sender in accordance with various embodiments of the present invention.

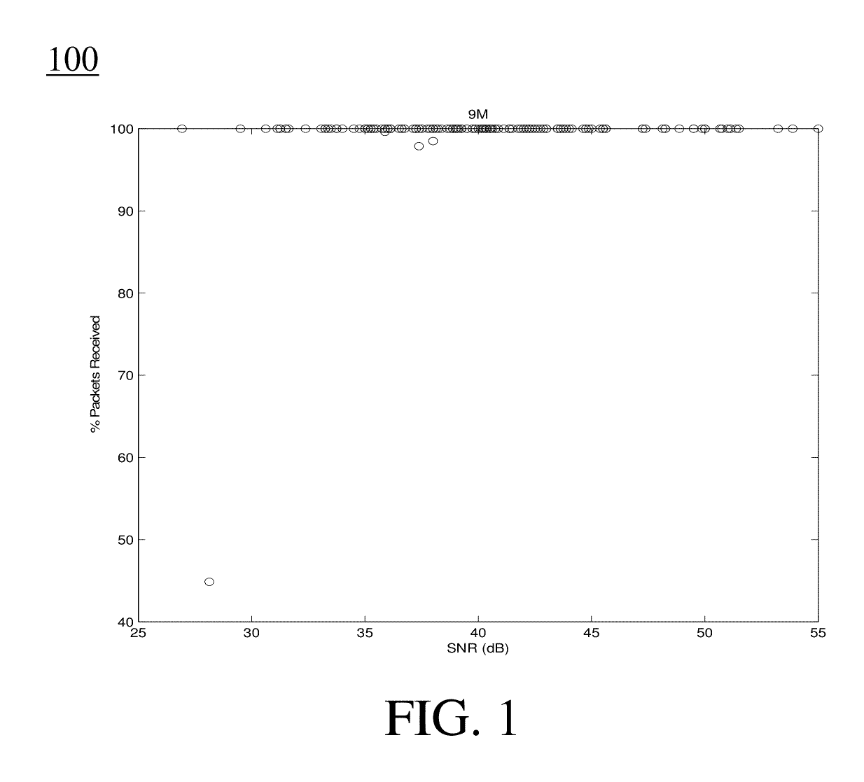

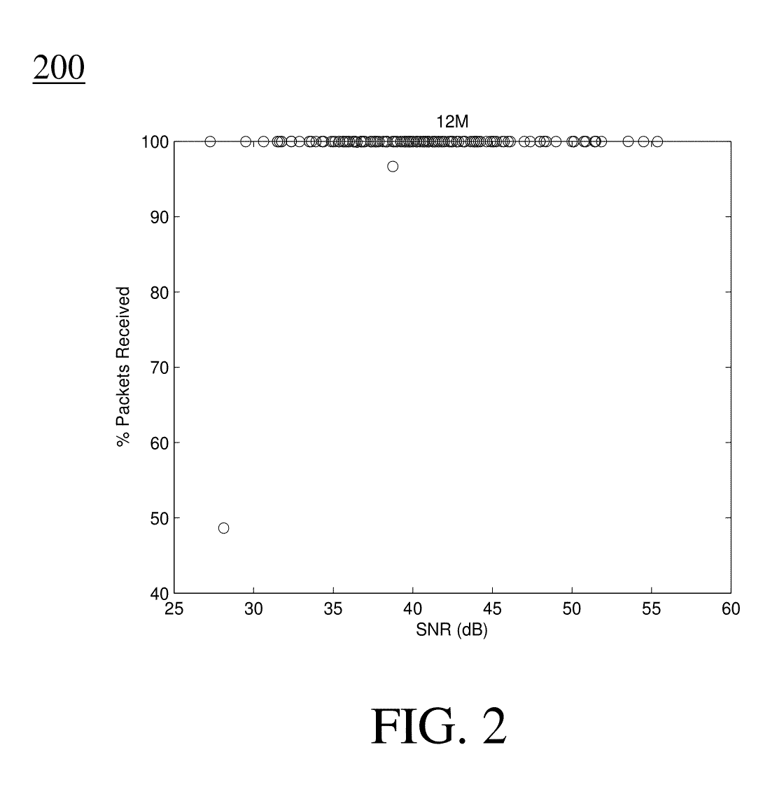

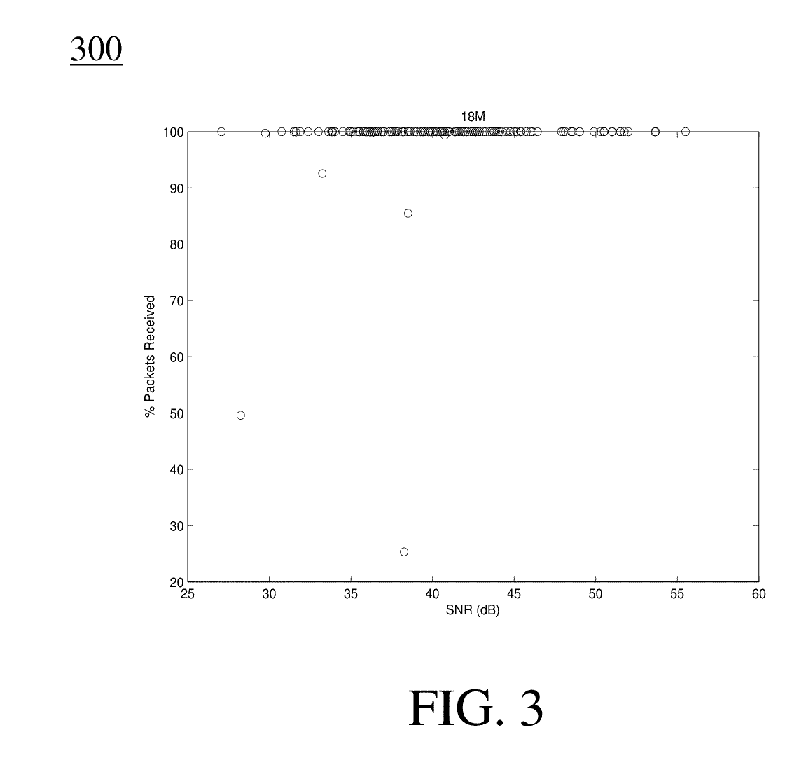

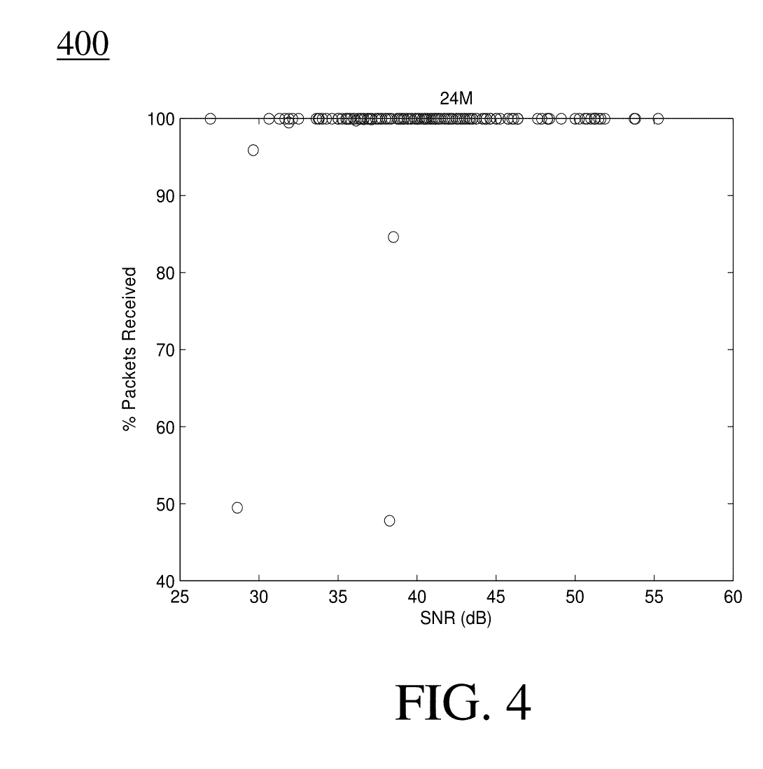

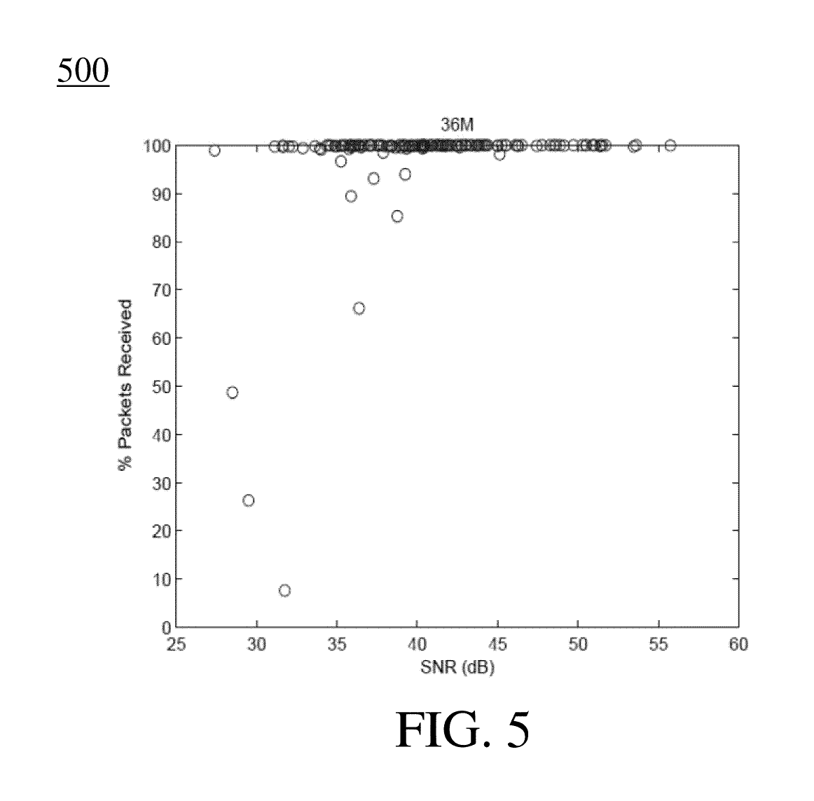

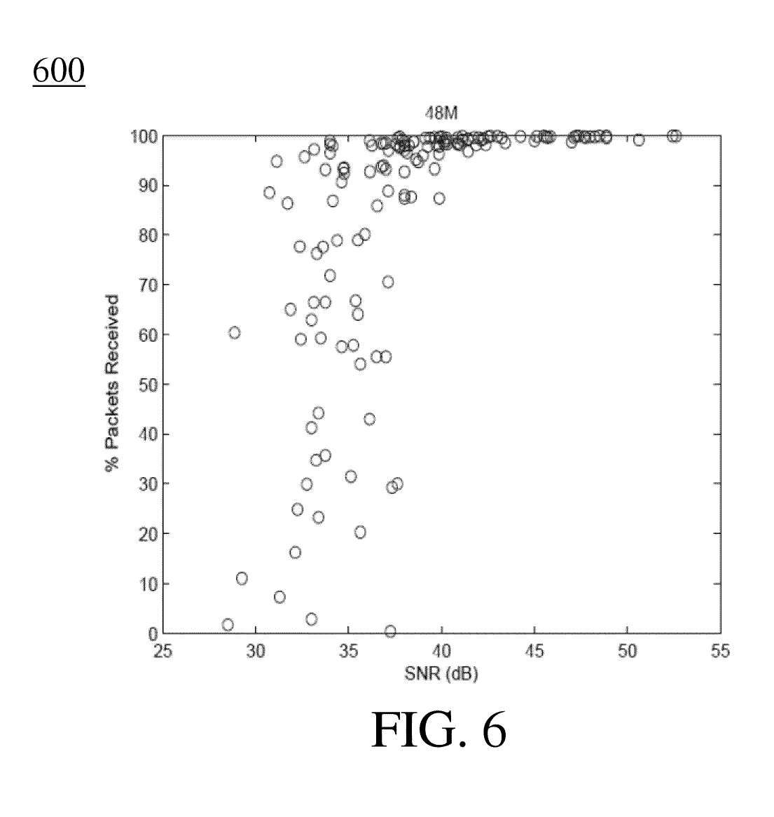

Specific embodiments of the present invention are disclosed below with reference to FIGS. 1-7. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY

Various methods and devices are provided to address the need for improved multicast operation. In one method, a sender transmits multicast transmissions at a first transmission rate to a multicast group of mobile devices that includes a group of feedback mobile devices. The sender receives, from each feedback mobile device of the group of feedback mobile devices, multicast receive quality feedback corresponding to the multicast transmissions. It is then determined which of the feedback mobile devices of the group of feedback mobile devices are abnormal based on the multicast receive quality feedback received from each feedback mobile device. A new transmission rate for subsequent multicast transmissions to the multicast group of mobile devices is then determined using the multicast receive quality feedback received from each feedback mobile device and the determination of which feedback mobile devices are abnormal. An article of manufacture is also provided, the article comprising a non-transitory, processor-readable storage medium storing one or more software programs which when executed by one or more processors performs the steps of this method.

Many embodiments are provided in which the method above is modified. For example, in many embodiments the sender transmits subsequent multicast transmissions at the new transmission rate to the multicast group of mobile devices. Also, in many embodiments the sender transmits an indication of which feedback mobile devices are determined abnormal. In some embodiments, each of the feedback mobile devices determined to be abnormal has an associated packet delivery ratio at or below the predetermined minimum packet delivery ratio. Also, in some embodiments the number of feedback mobile devices determined to be abnormal is at most a predetermined maximum percentage of the number of mobile devices in the multicast group.

In some embodiments, determining the new transmission rate involves selecting the new transmission rate such that, for the feedback mobile devices not determined to be abnormal, at least a predetermined threshold multicast receive quality level is achieved. Depending on the embodiment, the multicast receive quality feedback that is received by the sender from each feedback mobile device of the group of feedback mobile devices may comprise an indication of a packet delivery ratio corresponding to the multicast transmissions and/or an indication of channel quality (such as a signal-to-noise ratio) corresponding to the multicast transmissions. Also depending on the embodiment, determining the new transmission rate may involve selecting the new transmission rate such that, for the feedback mobile devices not determined to be abnormal, at least a predetermined minimum packet delivery ratio is achieved, or in other embodiments, at least a predetermined minimum channel quality (such as a predetermined minimum signal-to-noise ratio) is achieved.

A transceiver node apparatus is also provided. The transceiver node includes a transceiver and a processing unit, communicatively coupled to the transceiver. The processing unit is configured to transmit via the transceiver multicast transmissions at a first transmission rate to a multicast group of mobile devices that includes a group of feedback mobile devices and to receive, via the transceiver from each feedback mobile device of the group of feedback mobile devices, multicast receive quality feedback corresponding to the multicast transmissions. The processing unit is also configured to determine which of the feedback mobile devices of the group of feedback mobile devices are abnormal based on the multicast receive quality feedback received from each feedback mobile device and to determine a new transmission rate for subsequent multicast transmissions to the multicast group of mobile devices using the multicast receive quality feedback received from each feedback mobile device and the determination of which feedback mobile devices are abnormal. Many embodiments are provided in which this transceiver node is modified. Examples of such embodiments can be found described above with respect to the method.

### DETAILED DESCRIPTION OF EMBODIMENTS

To provide a greater degree of detail in making and using various aspects of the present invention, a description of our approach to improving multimedia content delivery and a description of certain, quite specific, embodiments follows for the sake of example. FIGS. 1-6 are referenced to provide some examples of specific simulation results that illustrate the problems that specific embodiments of the present invention may solve.

In related applications Ser. Nos. 12/962,362 and 13/031,395, we attempt to address the lack of a feedback mechanism in wireless multicast transmission by selecting a few of the receivers as feedback (FB) nodes to report to the multicast sender/transceiver node (e.g., base station or access point) regarding the quality of the received multicast service. Based on these reports the base station tunes the multicast transmission parameters. For instance, the base station may change the data transmission bit-rate (termed data rate), add FEC (forward-error-correction) codes, etc.

Our recent experiments show that even in controlled environments, a few of the nodes may suffer from poor service quality, while the vast majority of the nodes experience excellent service. We refer to these nodes as abnormal nodes and they typically report very low signal-to-noise ratio (SNR) or Packet Delivery Ratio (PDR). Unfortunately, these negligible number of abnormal nodes are typically selected as the FB nodes, due to the poor service quality that they experience. As a result, the system may operate at a very low data rate to satisfy the abnormal nodes while compromising the network utilization and significantly reducing the amount and quality of multimedia content that can be provided by the system.

To address this, we propose a simple yet efficient mechanism to balance between the number of users that benefit from the service vs. the network utilization. More specifically, we propose a mechanism that efficiently identifies the few abnormal nodes and ignores their feedback when tuning the system parameters. The solution ensures that the vast majority of the users are able to benefit from high quality multimedia services while keeping network utilization high.

We present a light-weight solution for scalable delivery of rich multimedia content to a large number of users in a small geographical region by means of WiFi multicast or cellular multicast. Our solution is an attractive method for delivering live video content to a large user population that share common interests. For instance, in a sports arena, our approach can be used for providing simultaneous video feeds of multiple camera angles.

In order to use wireless multicast to efficiently transmit a data stream to mobile nodes (mobile devices), the wireless base station (i.e., multicast sender transceiver node) dynamically adjusts the transmission data rate such that the majority of the mobile nodes receive an adequate amount of data (for example, at least a certain percentage, typically 95%, of the packets). The base station (transceiver node) in the wireless system may be an Access Point (AP) in WiFi or a Base Station (BS) in cellular networks, for example.

There are various metrics each mobile node can rely on to measure the quality of received multicast data. The following list contains metrics based on information from different protocol layers:
(1) PHY layer receiver signal to noise ratio (SNR),
(2) Bit Error Rate (BER) based on PHY layer information reported to MAC layer,
(3) MAC level frame reception statistics, and
(4) Packet Data Rate or Packet Delivery Ratio at IP layer
   To build our multicast system without relying on access to the PHY layer or MAC layer, Packet Delivery Ratio (PDR) is chosen as the indicator for the quality of the multicast reception at each mobile node.

It is a well established fact that wireless multicast channel quality varies with time, mobile location, and interference among other factors. Therefore, it is necessary to periodically determine the quality of the multicast reception at mobile nodes in order for the base station to adjust the multicast transmission rate. The goal of the multicast rate adjustment is for a majority (for example, at least X %=95%) of the mobile nodes to receive the multicast stream with a PDR value above a certain threshold S (for example, S=95%-99%) such that mechanisms at layers higher than the IP layer can deal with the missing packets effectively. Depending on the application that uses the multicast data, higher layer mechanisms may be performing one or more of the following:
(1) Adding Forward Error Correction (FEC) to the higher layer protocol
(2) Relying on multimedia encoding techniques that can tolerate packet losses
(3) Packet retransmission

In light of the above understanding of the nature of wireless multicast, service providers would likely structure their service level agreements (SLAs) as follows: The multicast service is guaranteed to use an adequate transmission bit rate such that at least X % of all mobile nodes in the multicast group will experience a PDR greater than or equal to S. In order to offer this type of SLA, the multicast BS should periodically receive PDR statistics from mobile nodes in the multicast group and dynamically adjust its transmission data rate.

A simpler yet similar problem exists in unicast transmission where the BS adjusts its data transmission rate to an individual mobile node based on a report of channel conditions from the BS to the mobile node. In this case, the only input to the data rate adjustment mechanism is the channel condition from the BS to exactly one mobile node.

With multicast, the single multicast data transmission rate impacts multiple mobile nodes and results in different conditions for multiple channels (we use PDR in this example). How the BS uses the multiple PDR values to guide the selection of a transmission data rate is challenging. A problem we try to address is how to identify which PDR values to use in selecting the one proper multicast transmission data rate, given that channel feedback reports (in terms of PDRs) are provided only from a subset of the receivers, that is, the FB nodes.

We study the problem of PDR value selection under the following model:
(1) The BS has the group membership information. 3GPP and 3GPP2 standard specifications have provided mechanisms using Internet Group

Management Protocol (IGMP) for the cellular network to track group membership changes through join and leave operations. IGMP may also be added to the IEEE 802.11 WLAN standard for group membership management. See S. Cocorada, Improving Multicast Group Management in IEEE 802.11 Wireless Networks, In Proc. Of Optimization of Electrical and Electronic Equipment (OPTIM) 2008.
(2) Each mobile node within the multicast group continuously calculates its received PDR.
(3) Each mobile node has the ability to establish a unicast channel with the BS and send a message to the BS.
(4) The BS determines what to do with its multicast transmission rate based on the received PDR values.

One design is for each mobile node to send its PDR value to the BS periodically. Based on the list of PDR values from all group members, the BS can easily identify the value of X % and the PDR value P such that at least X % of all mobile nodes in the multicast group report PDR values greater than or equal to the value P. As the next step, the BS can adjust its multicast transmission data rate to the threshold value S such that at least X % of all mobile nodes in the group experience PDR values at least S, which satisfies the SLA. However, the design that requires each mobile node to periodically report its PDR back to the BS is not scalable as the group size grows.

FIGS. 1-6 demonstrate abnormal (ABN) nodes in the case of a 802.11-a network with over 150 receivers and a single transceiver node/access point (AP), when the multicast data transmission bit-rate from the AP changes from 9 Mbps to 48 Mbps. We solve the PDR value selection problem under the framework of Feedback (FB) nodes. We have derived a mechanism for mobile nodes to organize themselves around neighborhoods based on their proximity to one another. See e.g., related applications Ser. Nos. 12/962,362 and 13/031,395. A mobile node that experiences the lowest PDR value among all its neighbors with a distance at most D becomes a FB node. Only a FB node reports its PDR value to the BS periodically. Any mobile node with a distance less than or equal to D from a reference mobile node is called “D-adjacent” to the reference mobile node. We assume the location of each mobile node in the multicast group is periodically updated at the BS.

One key is for the BS to examine the PDR values reported from all the FB nodes and iteratively mark certain FB nodes as “abnormal (ABN)” under an “abnormity test.” The marking process stops either when at least X % of all mobile nodes in the group have been marked as abnormal, or the abnormity test returns false.

At the end of this process, we are guaranteed to mark at most X % of all mobile nodes in the group as abnormal. Since all the abnormal nodes are FB nodes before they are marked abnormal, the BS keeps track of their PDR values. Therefore, the BS obtains the PDR value P which is the largest PDR value experienced by the set of abnormal nodes. Note that P is also the minimal PDR value among all the normal FB nodes.

The BS conducts the “abnormity test” for the FB node currently reporting the lowest PDR in the multicast system. The goal of the “abnormity test” is to identify FB nodes that report significantly lower PDR values than other FB nodes in the multicast group.

This test is motivated by our observation from our WiFi multicast test bed with 150 receivers as demonstrated in FIGS. 1-6. These figures show the PDR vs. the SNR for different bit-rates between 9 Mbps to 48 Mbps. In all the figures we observe repeatable patterns. In graphs 100, 200, 300 and 400 (data rate of 9-24 Mbps), we notice a few nodes (less than 5) always report significantly lower PDR than the rest of the multicast receivers. The identity and location of these nodes vary from test to test and vary under different multicast transmission data rates. In graphs 500 and 600, we notice that the number of nodes with low PDR increases significantly for data rates of 36 Mbps and 48 Mbps. These results demonstrate that the AP can transmit with a bit-rate of 24 Mbps while ensuring excellent service (PDR>95%) for the vast majority (>97%) of the receivers.

The goal of the “abnormity test” is to mark FB nodes as abnormal (ABN) nodes one by one with increasing PDR values until we find the PDR value P reported by the last FB node such that either the “abnormity test” fails or the number of ABN nodes marked have become X% of all multicast receivers. At which point, we can guarantee that
(1) all ABN nodes experience PDR value at most P, and
(2) all ABN nodes constitute at most X % of all multicast receivers
   From the BS's perspective, the multicast quality experienced by the entire group can be represented by the PDR value P. Therefore, the BS can invoke the dynamic rate adjustment mechanism to adjust (increase, decrease or keep the same) its multicast data transmission rate such that this PDR value P is greater than or equal to the PDR threshold value S specified in the SLA.

Now we describe an “abnormity test” conducted at the BS using the following input parameters:
(1) PDR values from all FB nodes
(2) Location of FB nodes in the form of (x, y)-coordinates
Step 1: select the FB node with the lowest PDR value from all FB nodes, and name it the reference FB node in this iteration
Step 2: Select a neighborhood of the reference FB node that is at most a*D unit distance away from the reference FB node. We call this neighborhood the “a*D-adjacency neighborhood” of reference FB node. Identify a few categories of FB nodes based on their distance d to the reference FB node.

$$\begin{matrix}\begin{matrix}\begin{matrix}G 1 \text{:} 0 < d <= D \\ G 2 \text{:} D < d , <= 2 * D\end{matrix} \\ G 3 \text{:} 2 * D < d <= 3 * D\end{matrix} \\ … \\ Ga \text{:} ( a - 1 ) * D < d <= a * D\end{matrix}$$

Step 3: calculate statistics for the a*D-adjacency neighborhood for the reference FB node. The statistics include mean, weighted mean and variance or standard deviation (std). When using weighted mean, we have the option to assign more weight to FB nodes that are closer to the reference FB node. The goal is to identify a FB node with the local minimum PDR value that is far enough from its neighboring FB nodes.
Step 4: Based on the statistics, conduct the abnormity by checking if the reference FB node with PDR f satisfies the condition

(f<m−b*sdv),

where m and sdv is the weighted average and standard deviation of the PDR values reported by FB nodes in its a*D-adjacency neighborhood respectively, and b is a parameter that controls the sensitivity of the abnormity test. (An example for calculating m and sdv is given below).
If (f<m−b*sdv), then the test is successful and we label the reference FB node as an ABN node and move to step 5.
Otherwise, the test is not successful. Thus the BS has identified all ABN nodes in the system, and can stop the test.
   For calculating the mean m and the standard deviation sdv we associate to each FB node “v” a weight according to its distance to the reference FB node. For instance, consider the set of FB nodes in the category Gi as described in Step 2. For every FB node v in Gi we associate a weight:

$${w}_{v} = \frac{1}{C * {i}^{β}}$$

Where 1≦β insures that the impact of the FB node categories is diminishing with their distance from the reference FB node and C is a normalized parameter given by:

$$C = {\sum }_{i = 1}^{a} \frac{\vert {G}_{i} \vert}{{i}^{β}}$$

Then m and sdv are calculated by

$$m = {\sum }_{FB node v}^{ } {w}_{v} * {PDR}_{v}$$

$$sdv = \sqrt{( {\sum }_{FB node v}^{ } {w}_{v} * {( {PDR}_{v} - m )}^{2} )}$$

Step 5: The BS stops the just identified ABN node from being the FB node. However, the ABN node is required to periodically send its PDR to the BS. In fact, we can consider an ABN node as a FB node for the 0-adjacency neighborhood around itself. It only reports the channel condition in terms of PDR for itself.

The ABN node stops its role as a FB node triggers another round of FB node selection process. As a result, one or more non-FB nodes become the new FB nodes that represent the D-adjacency neighborhood for the ABN node labeled in step 4, unless the ABN node does not have any D-adjacent neighbors. Once this process settles, we go to step 1.

Note that the abnormity test runs in iterations. During each iteration, exactly one FB node is labeled as an ABN node and at the end of the process, either all FB nodes with local minimum PDR values significantly lower than that of its neighbors are marked as ABN nodes, or the number of ABN nodes have increased to X% of all mobile nodes in the multicast group as specified in the SLA.

### Example Results:

We set X %=3% and minimal PDR>95%; there are 150 nodes in the multicast group in our tests. In the example shown in FIGS. 1-6, without any interference and while using a multicast bit-rate below 36 Mbps, there are at most 4 nodes experiencing lower PDRs (<95%) than the rest of the nodes in the multicast group. Only these 4 nodes would be identified as ABN nodes.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

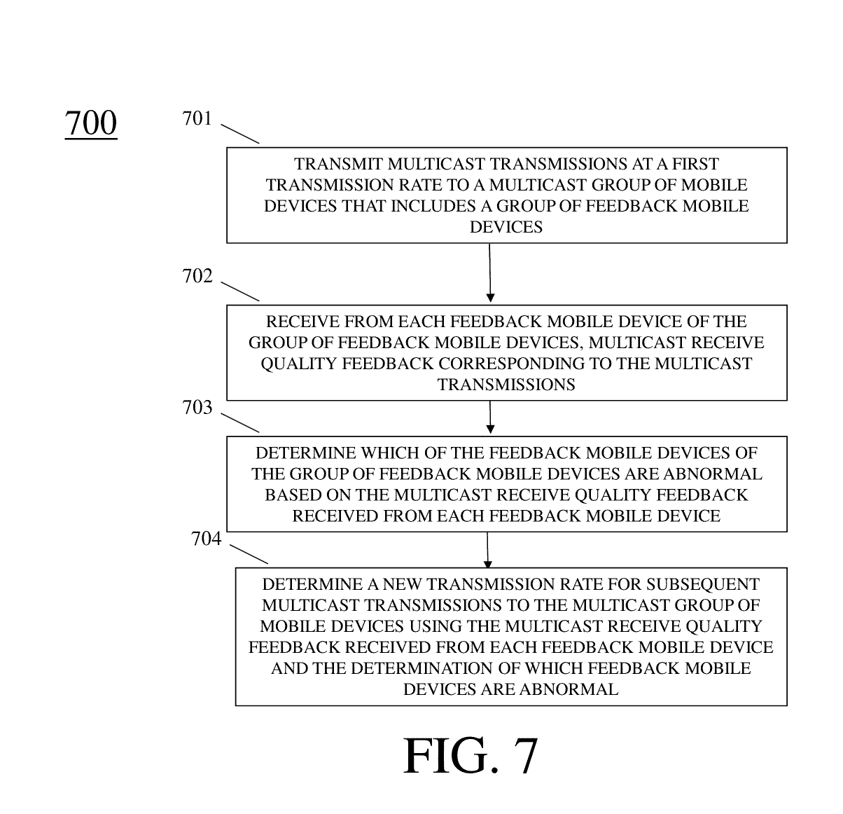

Aspects of embodiments of the present invention can also be understood with reference to FIG. 7. Diagram 700 of FIG. 7 is a logic flow diagram of functionality performed by a multicast sender in accordance with various embodiments of the present invention. In the method depicted in diagram 700, a sender transmits (701) multicast transmissions at a first transmission rate to a multicast group of mobile devices that includes a group of feedback mobile devices. The sender receives (702), from each feedback mobile device of the group of feedback mobile devices, multicast receive quality feedback corresponding to the multicast transmissions. It is then determined (703) which of the feedback mobile devices of the group of feedback mobile devices are abnormal based on the multicast receive quality feedback received from each feedback mobile device. A new transmission rate for subsequent multicast transmissions to the multicast group of mobile devices is then determined (704) using the multicast receive quality feedback received from each feedback mobile device and the determination of which feedback mobile devices are abnormal. An article of manufacture is also provided, the article comprising a non-transitory, processor-readable storage medium storing one or more software programs which when executed by one or more processors performs the steps of this method.

Many embodiments are provided in which the method above is modified. For example, in many embodiments the sender transmits subsequent multicast transmissions at the new transmission rate to the multicast group of mobile devices. Also, in many embodiments the sender transmits an indication of which feedback mobile devices are determined abnormal.

Regarding the abnormal determination (as in 703, e.g.), in some embodiments, each of the feedback mobile devices determined to be abnormal has an associated packet delivery ratio at or below the predetermined minimum packet delivery ratio. Also, in some embodiments the number of feedback mobile devices determined to be abnormal is at most a predetermined maximum percentage of the number of mobile devices in the multicast group.

In some embodiments, determining the new transmission rate (as in 704, e.g.)

involves selecting the new transmission rate such that, for the feedback mobile devices not determined to be abnormal, at least a predetermined threshold multicast receive quality level is achieved. Depending on the embodiment, the multicast receive quality feedback that is received by the sender from each feedback mobile device may comprise an indication of a packet delivery ratio corresponding to the multicast transmissions and/or an indication of channel quality (such as a signal-to-noise ratio) corresponding to the multicast transmissions. Also, depending on the embodiment, determining the new transmission rate may involve selecting the new transmission rate such that, for the feedback mobile devices not determined to be abnormal, at least a predetermined minimum packet delivery ratio is achieved, or in other embodiments, at least a predetermined minimum channel quality (such as a predetermined minimum signal-to-noise ratio) is achieved.

The operation of a multicast sender, such as described with respect to diagram 700, may be performed by a transceiver node apparatus that includes a transceiver and a processing unit, communicatively coupled to the transceiver. The processing unit is configured to transmit via the transceiver multicast transmissions at a first transmission rate to a multicast group of mobile devices that includes a group of feedback mobile devices and to receive, via the transceiver from each feedback mobile device of the group of feedback mobile devices, multicast receive quality feedback corresponding to the multicast transmissions. The processing unit is also configured to determine which of the feedback mobile devices of the group of feedback mobile devices are abnormal based on the multicast receive quality feedback received from each feedback mobile device and to determine a new transmission rate for subsequent multicast transmissions to the multicast group of mobile devices using the multicast receive quality feedback received from each feedback mobile device and the determination of which feedback mobile devices are abnormal. Many embodiments are provided in which this transceiver node is modified.

In general, components such as processing units and transceivers in a transceiver node apparatus are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, the transceiver node apparatus represents a known device that has been adapted, in accordance with the description herein, to implement multiple embodiments of the present invention. Furthermore, those skilled in the art will recognize that aspects of the present invention may be implemented in and across various physical components and none are necessarily limited to single platform implementations. For example, the processing unit may be implemented in or across one or more network components.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method for improved multicast rate control using feedback mobiles, the method comprising:
transmitting by a sender multicast transmissions at a first transmission rate to a multicast group of mobile devices that includes a group of feedback mobile devices;
receiving, by the sender from each feedback mobile device of the group of feedback mobile devices, multicast receive quality feedback corresponding to the multicast transmissions;
determining which of the feedback mobile devices of the group of feedback mobile devices are abnormal based on the multicast receive quality feedback received from each feedback mobile device;
determining a new transmission rate for subsequent multicast transmissions to the multicast group of mobile devices using the multicast receive quality feedback received from each feedback mobile device and the determination of which feedback mobile devices are abnormal.

2. The method of claim 1, wherein determining the new transmission rate comprises
selecting the new transmission rate such that, for the feedback mobile devices not determined to be abnormal, at least a predetermined threshold multicast receive quality level is achieved.

3. The method of claim 1, wherein receiving, by the sender from each feedback mobile device of the group of feedback mobile devices, multicast receive quality feedback corresponding to the multicast transmissions comprises
receiving, from each feedback mobile device of the group of feedback mobile devices, an indication of a packet delivery ratio corresponding to the multicast transmissions.

4. The method of claim 3, wherein determining the new transmission rate comprises
selecting the new transmission rate such that, for the feedback mobile devices not determined to be abnormal, at least a predetermined minimum packet delivery ratio is achieved.

5. The method of claim 4, wherein each of the feedback mobile devices determined to be abnormal has an associated packet delivery ratio at or below the predetermined minimum packet delivery ratio.

6. The method of claim 3, wherein the number of feedback mobile devices determined to be abnormal is at most a predetermined maximum percentage of the number of mobile devices in the multicast group.

7. The method of claim 1, wherein determining the new transmission rate comprises
selecting the new transmission rate such that, for the feedback mobile devices not determined to be abnormal, at least a predetermined minimum channel quality is achieved.

8. The method of claim 7, wherein the predetermined minimum channel quality comprises a predetermined minimum signal-to-noise ratio.

9. The method of claim 1, further comprising
transmitting by the sender subsequent multicast transmissions at the new transmission rate to the multicast group of mobile devices.

10. The method of claim 1, further comprising
transmitting by the sender an indication of which feedback mobile devices are determined abnormal.

11. An article of manufacture comprising a non-transitory, processor-readable storage medium storing one or more software programs which when executed by one or more processors performs the steps of the method of claim 1.

12. A transceiver node of a communication system, the transceiver node comprising:
a transceiver;
a processing unit, communicatively coupled to the transceiver, configured
to transmit via the transceiver multicast transmissions at a first transmission rate to a multicast group of mobile devices that includes a group of feedback mobile devices,
to receive, via the transceiver from each feedback mobile device of the group of feedback mobile devices, multicast receive quality feedback corresponding to the multicast transmissions,
to determine which of the feedback mobile devices of the group of feedback mobile devices are abnormal based on the multicast receive quality feedback received from each feedback mobile device, and
to determine a new transmission rate for subsequent multicast transmissions to the multicast group of mobile devices using the multicast receive quality feedback received from each feedback mobile device and the determination of which feedback mobile devices are abnormal.

13. The transceiver node of claim 1, wherein being configured to determine the new transmission rate comprises
being configured to select the new transmission rate such that, for the feedback mobile devices not determined to be abnormal, at least a predetermined threshold multicast receive quality level is achieved.

14. The transceiver node of claim 1, wherein being configured to receive, from each feedback mobile device of the group of feedback mobile devices, multicast receive quality feedback corresponding to the multicast transmissions comprises
being configured to receive, from each feedback mobile device of the group of feedback mobile devices, an indication of a packet delivery ratio corresponding to the multicast transmissions.

15. The transceiver node of claim 14, wherein being configured to determine the new transmission rate comprises
being configured to select the new transmission rate such that, for the feedback mobile devices not determined to be abnormal, at least a predetermined minimum packet delivery ratio is achieved.

16. The transceiver node of claim 15, wherein each of the feedback mobile devices determined to be abnormal has an associated packet delivery ratio at or below the predetermined minimum packet delivery ratio.

17. The transceiver node of claim 14, wherein the number of feedback mobile devices determined to be abnormal is at most a predetermined maximum percentage of the number of mobile devices in the multicast group.

18. The transceiver node of claim 12, wherein being configured to determine the new transmission rate comprises
being configured to select the new transmission rate such that, for the feedback mobile devices not determined to be abnormal, at least a predetermined minimum channel quality is achieved.

19. The transceiver node of claim 12, wherein the processing unit is further configured
to transmit via the transceiver subsequent multicast transmissions at the new transmission rate to the multicast group of mobile devices.

20. The transceiver node of claim 12, wherein the processing unit is further configured
to transmit via the transceiver an indication of which feedback mobile devices are determined abnormal.
